(19) United States
(12) Patent Application Publication
(10) Pub. No.: US 2011/0107059 A1
(43) Pub. Date: May 5, 2011

(54) MULTILAYER PARALLEL PROCESSING APPARATUS AND METHOD

(75) Inventors: Sang Yoon OH, Daejeon-si (KR); Bhum-Cheol LEE, Daejeon-si (KR); Jung-Hee LEE, Daejeon-si (KR); Dong-Myoung BAEK, Daejeon-si (KR); Seung-Woo LEE, Daejeon-si (KR)

(73) Assignee: Electronics and Telecommunications Research Institute, Daejeon-si (KR)

(21) Appl. No.: 12/916,833

(22) Filed: Nov. 1, 2010

(30) Foreign Application Priority Data
Nov. 5, 2009 (KR) 10-2009-0106599
Apr. 27, 2010 (KR) 10-2010-0039211

(51) Int. Cl. G06F 15/80; G06F 9/02

(52) U.S. Cl. 712/18; 712/E09.002

(57) ABSTRACT

A multilayer parallel processing apparatus. The multilayer parallel processing apparatus includes two or more hierarchical parallel processing units, each configured to process flow data corresponding to a hierarchy that is allocated thereto in response to inputting pieces of flow data configured with two or more hierarchies, and a common database configured to be accessed by the two or more hierarchical parallel processing units and store processing results of each of the hierarchical parallel processing units.

### CROSS-REFERENCE TO RELATED APPLICATION(S)

This application claims the benefit under 35 U.S.C. §119(a) of Korean Patent Application Nos. 10-2009-0106599, filed on Nov. 5, 2009, and 10-2010-0039211, filed on Apr. 27, 2010, the entire disclosures of which are incorporated herein by reference for all purposes.

### BACKGROUND

1. Field

The following description relates to a multi-processing apparatus and method, and more particularly, to a parallel processing apparatus and method of a multiprocessor.

2. Description of the Related Art

A multiprocessor is advantageous in terms of data processing capability and power consumption, and can be implemented with various programs installed therein. Thus, it is expected that the above advantages of the multiprocessor allow increasing application of the multi-processor in various fields such as terminals, electric appliances, communications, and broadcasting. According to Amdahl's law, speedup of processing of a multiprocessor may be represented by Equation 1 as below.

S=1/(1−fp+fp/n) (1),

, where fp denotes parallel fraction of a code, and n denotes the number of processors.

As shown in Equation 1, the overall speedup of processing of the multiprocessor is involved with a parallel processing rate. That is, if the parallel processing rate is small, the overall processing speed of the multiprocessor does not increase but is saturated even when the number of individual processors of the multiprocessor is increased.

Meanwhile, around the year of 2000, a multiprocessor started to be utilized in a network processor to improve a packet processing speed in a network including layer 1 to layer 4. As known from Amdahl's law, to increase a parallel processing speed linearly, parallel processing portions should be substantially more than series processing portions. Prior arts have been introduced to improve parallel processing capabilities by use of a structure of Amdahl's law for increasing a parallel processing rate.

Such prior arts reduce a series processing rate of each individual processor of a multiprocessor, and increase a parallel processing rate, so that the parallel processing speed is increased linearly with the number of processors according to Amdahl's law. In particular, head-of-line blocking can be reduced, and accordingly packet processing time is advantageously reduced.

However, if tasks such as classification, forwarding, filtering, and inspection, or data is which are to be processed are increased in numbers, a parallel processing rate of each individual processor is reduced.

### SUMMARY

The following description relates to a multiprocessor apparatus and method for increasing a parallel processing speed.

In addition, the following description relates to a multiprocessor apparatus and method for increasing a speed of parallel processing data having a multilayer structure.

In one general aspect, provided is a multilayer parallel processing apparatus including: two or more hierarchical parallel processing units, each configured to process flow data corresponding to a hierarchy that is allocated thereto in response to inputting pieces of flow data configured with two or more hierarchies; and a common database configured to be accessed by the two or more hierarchical parallel processing units and store processing results of each of the hierarchical parallel processing units.

In another general aspect, provided is a multilayer parallel processing method in a multilayer parallel processing apparatus which comprises two or more hierarchical parallel processing units and a common database, the multilayer parallel processing method including: receiving pieces of flow data, each configured with two or more hierarchies; identifying flow data corresponding to an allocated hierarchy from the received flow data and processing the identified flow data; and storing a processing result of the flow data to the common database.

Other features and aspects will be apparent from the following detailed description, the drawings, and the claims.

### BRIEF DESCRIPTION OF THE DRAWINGS

FIG. 1 is a diagram illustrating an example of data having a multilayer structure.

FIG. 2 is a diagram illustrating an example of a multilayer parallel processing apparatus.

FIG. 3 is a diagram illustrating an example of a memory table of the common database.

FIG. 4 is a diagram illustrating another example of a memory table of the common database.

FIG. 5 is a diagram illustrating an example of a data flow processing method of a multilayer parallel processing apparatus.

FIG. 6 is a diagram illustrating an example of a configuration of a multilayer parallel processing apparatus performing deep packet classification (DPC).

FIG. 7 is a diagram illustrating an example of a memory table of the layer 2-7 database configured based on the example shown in FIG. 4.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Also, descriptions of well-known functions and constructions may be omitted for increased clarity and conciseness.

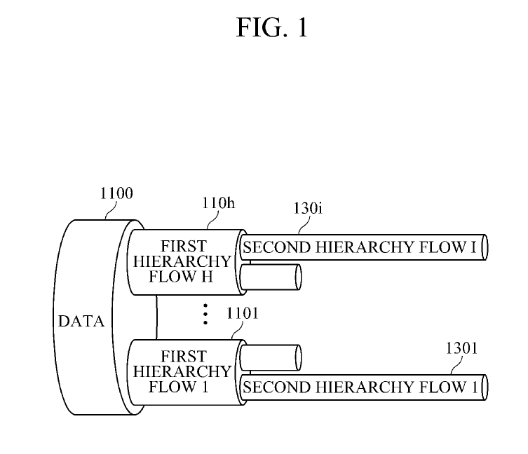

FIG. 1 illustrates an example of data having a multilayer structure. Referring to FIG. 1, the input data 1100 has two kinds of hierarchies.

The input data 1100 is generated as pieces of flow data by using pieces of information 1101, . . . , 110h corresponding to a first hierarchy and pieces of information 1301, . . . , 130i corresponding to a second hierarchy. In the example, the flow data of the first hierarchy and of the second hierarchy which is different from the first hierarchy in properties are processed in parallel to increase a parallel processing speed.

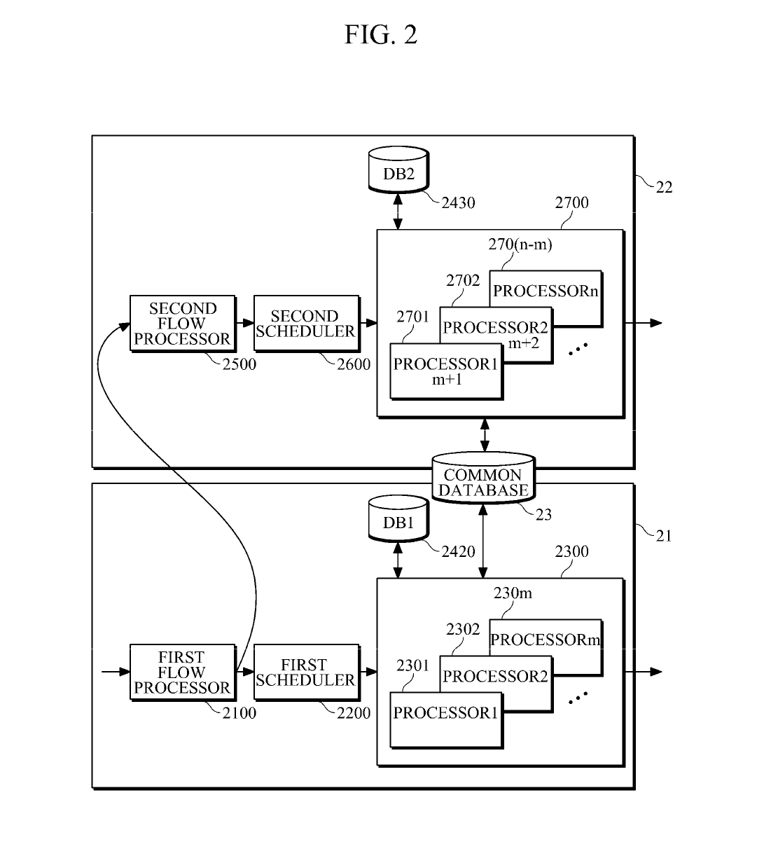

FIG. 2 illustrates an example of a multilayer parallel processing apparatus.

The multilayer parallel processing apparatus includes two or more parallel processing units and a common database that the parallel processing units can access in common. In the example illustrated in FIG. 2, the multilayer parallel processing apparatus is assumed to include a first hierarchical parallel processing unit 21 and a second hierarchical parallel processing unit 22.

The first hierarchical parallel processing unit 21 includes a first flow processor 2100, a first scheduler 2200, a first multiprocessor array 2300, and a first database 2420. The first multiprocessor array 2300 includes m processors 2301, . . . , 230m. Here, m is a natural number.

The second hierarchical parallel processing unit 22 includes a second flow processor 2500, a second scheduler 2600, a second multiprocessor array 2700, and a second database 2430. The second multiprocessor array 2700 includes n-m processors including an m+1 processor 2701 to an n processor 270(n-m). Here, n is a natural number greater than m.

The common database 23 is accessed by both the first hierarchical parallel processing unit 21 and the second hierarchical parallel processing unit 22.

The first hierarchical parallel processing unit 21 will now be described in detail.

The first flow processor 2100 uses first hierarchy information and a first hierarchy classification rule which are contained in incoming data to generate a first hierarchy flow identification (ID) corresponding to the incoming data. The first hierarchy information is may be header, the first hierarchy classification rule may be a hash function, and the first hierarchy flow ID may be a hash value of the first hierarchy which is generated using a hash key of the header and the hash function. Alternatively, the hash key of the header may be used as the first hierarchy flow ID.

In this case, two or more pieces of flow data with the same ID may be generated, and hereinafter such flow data having the same ID will be referred to as “same-type flow data.”

To classify pieces of the same type flow data by the input order or time, the first flow processor 2100 assigns sequence numbers to the pieces of flow data that constitute each flow according to the input order of the flow data. Alternatively, pieces of incoming data may be classified by time information about input time of flow data that constitutes each flow. Hereinafter, an example of assigning the sequence numbers will be described.

Pieces of data constituting each of the first hierarchy flows may be classified by the first hierarchy IDs and sequence numbers.

The first flow processor 2100 may classify and transmit incoming flow data according to the kind of hierarchy corresponding to the input data when the first hierarchy flow data processing and the second hierarchy flow data processing can be individually performed, and allow each hierarchy to copy and process the incoming flow data when one hierarchy needs to refer to data of another hierarchy.

The first scheduler 2200 allocates pieces of first hierarchy flow data to available processors included in the first multiprocessor array 2300 in such a manner that a pieces of same-type first hierarchy flow data are allocated to the same processor.

However, since the number of flow data possible to be processed by each processor is limited, it is not able to allocate all of the same-type flow data to one processor without limitation.

That is, under the assumption that each processor can be allocated with x pieces of is flow data, there may occur three cases when the first scheduler 220 allocates the pieces of first hierarchy flow data to the respective processors of the first multiprocessor array.

First, no more than x pieces of same-type first hierarchy flow data may be consecutively input. In this case, the first scheduler 2200 allocates the pieces of input first hierarchy flow data, which are no more than x pieces, to one processor.

Second, more than x pieces of same-type first hierarchy flow data may be input. In this case, the first scheduler 2200 primarily allocates x pieces of first hierarchy flow data to one processor, and allocates the rest of the input same-type first hierarchy flow data, from the (x+1)th first hierarchy flow data, to another processor.

In this case, if the latter processor is allocated with more than x pieces of same-type first hierarchy flow data, the first scheduler 2200 allocates pieces of first hierarchy flow data following the xth first hierarchy flow data, stating with the (x+1)th first hierarchy flow data, to a different processor other than the previous two processors.

Third, first hierarchy flow data may be input, a type of which is different from the type of first hierarchy flow data that is being processed in the first multiprocessor array 2300. In this case, the first scheduler 2200 assigns a new processor to process the input different-type first hierarchy flow data of the different type.

However, when the first scheduler 2200 allocates the pieces of first hierarchy flow data to each processor of the first multiprocessor array 2300 according to the above described methods, a sequence of first hierarchy flow data which have been processed by different processors may not be able to be maintained as initially allocated.

To prevent the above-mentioned problem, sequence numbers which are assigned to the respective first hierarchy flow data by the first flow processor 2100 are used. The first flow processor 2100 sets the number of cyclic sequence numbers to be greater than x, so that the order of processing the pieces of first hierarchy flow data can be maintained is according to the sequence numbers.

However, if the number of cyclic sequence numbers is significantly greater than x, it is easy to maintain the order of processing results of first hierarchy flow data, but it is disadvantageous in that hardware cost is increased.

If x is set to be small, the first scheduler 2200 allocates the pieces of the same-type first hierarchy flow data to a plurality of processors. In this case, while the parallel processing performance may be increased with the increase of then number of processors, the number of processors to be checked for the sequence numbers for maintaining the order of flow data is increased.

In contrast, if x is set to be large, the first scheduler 220 allocates the pieces of the same-type first hierarchy flow data to fewer processors than when x is set to be small. In this case, while the parallel processing performance is disadvantageously reduced due to the decrease of the number of processors, the number of processors to be checked for the sequence numbers for maintaining the order of flow data is reduced.

Thus, the number of the cyclic sequence numbers and x are optimally set by taking into consideration the maximum time of the first processor 2301 to the mth processor 230m of the first multiprocessor array 2300 for processing first hierarch flow data or the maximum time for processing the consecutive first hierarch flow data of the first multiprocessor array 2300.

The first processor 2301 to the mth processor 230m of the first multiprocessor array 2300 perform first hierarchy-related task on the corresponding first hierarchy flow data allocated by the first scheduler 2200. In addition, if necessary, the first multiprocessor array 2300 accesses the common database 23 which is accessed in common by the second hierarchical parallel processing unit 22 that will be described later, and accesses the first database 2420 dedicated to the first multiprocessor array 2300.

As described above, in the first multiprocessor array 2300, pieces of flow data are is allocated to different processors according to the type of the flow data to increase a parallel process rate, and the first multiprocessor array 2300 only performs the first hierarchy task, thereby increasing locality. It is accordingly expected to increase the overall parallel processing speed.

Hereinafter, the second hierarchy parallel processing unit 22 will now be described.

The second flow processor 2500 generates a second hierarchy flow ID by use of second hierarchy information and a second hierarchy classification rule contained in the first hierarchy flow data that includes the first hierarchy flow ID and information of the sequence number corresponding to the flow type, which have been generated by the first flow processor 2100 of the first hierarchy parallel processing unit 21. The second hierarchy information may be payload, the second hierarchy classification rule may be a second hash function, and the ID information may be a hash value of the second hierarchy which is generated from a hash key contained in the payload by means of the second hash function. Alternatively, a hash key contained in the payload may be set as the second hierarchy flow ID.

Here, like the above-described first hierarchy flow data, two or more pieces of second hierarchy flow data having the same ID may be generated, and hereinafter the pieces of flow data having the same ID will be referred to as “same-type flow data.”

Operation of the second flow processor 2500 assigning sequence numbers to pieces of second hierarchy flow data according to the input order or according to time of input and operation of the second scheduler 2600 allocating the pieces of second hierarchy flow data to the second multiprocessor array 2700 are, respectively, identical with the operations of the first flow processor 2100 and the first scheduler 220, and thus the detailed description will not be reiterated.

In addition, the second multiprocessor array 2700, if necessary, accesses the common database 23 which is accessed in common by the first hierarchy parallel processing is unit 21 and accesses the second database 2430 dedicated to the second multiprocessor array 2700.

An additional database may be required for allocating IDs for classifying flows by the first flow processor 2100 and the second flow processor 2500 on the base of the types of the flows and assigning sequence numbers for further classifying the classified flow data of the same type according to the input order or time of input.

The database includes a plurality of address fields, each of which records ID information according to the flow type, and a data field of a sequence field, which records data to which a sequence number is assigned for identifying the order of one or more pieces of flow data corresponding to the respective IDs.

In case of the presence of a large number of flow data or a special application, the first flow processor 2100 and the second flow processor 2500 may not assign the sequence numbers to all pieces of flow data, but may assign the sequence numbers to only a limited number of flow data. That is, a set of consecutive j pieces of flow data of arbitrary types is generated, and the sequence numbers are assigned up to j pieces of same-type flow data.

Hereinafter, operations of the first flow processor 2100 and the second flow processor 2500, each of which assigns the sequence numbers up to j pieces of flow data, will now be described.

The first flow processor 2100 and the second flow processor 2500 configure j pieces of consecutive flow data according to the generation order. The jth flow data is data currently generated, and the first flow data precedes (j−1) pieces of other consecutive flow data.

If the jth flow data is generated, each of the first flow processor 2100 and the second flow processor 2500 assigns sequence numbers only to the first flow data, the second flow data, . . . , and the jth flow data on the basis of the type of the flow data.

If the (j+i)th flow data is generated, the first flow processor 2100 and the second is flow processor 2500 assigns sequence numbers only to the second flow data, the third flow data, . . . , and the (j+1)th flow data on the basis of the type of the flow data. Among j pieces of consecutive flow data, only the same-type flow data are assigned with sequence numbers, starting with 1. If there are k (k is a natural number smaller than j) pieces of same-type flow data among the j pieces of consecutive flow data, the same-type flow data are assigned with sequence numbers from 1 to k sequentially.

In contrast, if types of the j pieces of consecutive input flow data are different from one another, each flow data is assigned with a sequence number 1.

If p pieces of same-type flow data are present among j pieces of consecutive input flow data of arbitrary types, flow data subsequent to the pth flow data are assigned circularly with sequence numbers from 1. In this case, to distinguish flow data which is assigned with a sequence number 1 after a cycle of sequence numbers 1 to p from flow data which is assigned with a sequence number 1 when the flow data, type of which is different from those of j pieces of consecutive flow data, is added to the j pieces of consecutive input flow data (or the flow data is first generated after the j pieces of consecutive flow data), a flag or a low-order bit is added to either flow data. For example, 11 is a sequence number after one cycle of sequence numbers, and 10 is a sequence number before one cycle of sequence numbers.

As described above, when the first flow processor 2100 and the second flow processor 2500 are configured to assign sequence numbers to a limited number of flow data, the number of flow processor memories can be reduced.

However, since the sequence numbers are not assigned consecutively to all flow data regardless of their types, but assigned individually according to the type of flow data, the above method is disadvantageous for an application that processes cross flow data.

Hereinafter, the common database 23 which is accessed in common by the first hierarchical parallel processing unit 21 and the second hierarchical parallel processing unit 22 will be described.

The common database 23 is accessed in common by the first multiprocessor array 2300 of the first hierarchical parallel processing unit 21 and the second multiprocessor array 2700 of the second hierarchical parallel processing unit 22. Thus, the common database 23 is required to be synchronized between the first multiprocessor array 2300 and the second multiprocessor array 2700.

To this end, information of the first hierarchy flow and information of the second hierarchy flow is needed to be matched with each other.

When flow data transmission time delay is ignored, flow data to be processed in the first hierarchy and flow data to be processed in the second hierarchy are the same, and thus the first hierarchy flow and the second hierarchy flow can be synchronized with each other by assigning a sequence number to the first hierarchy flow.

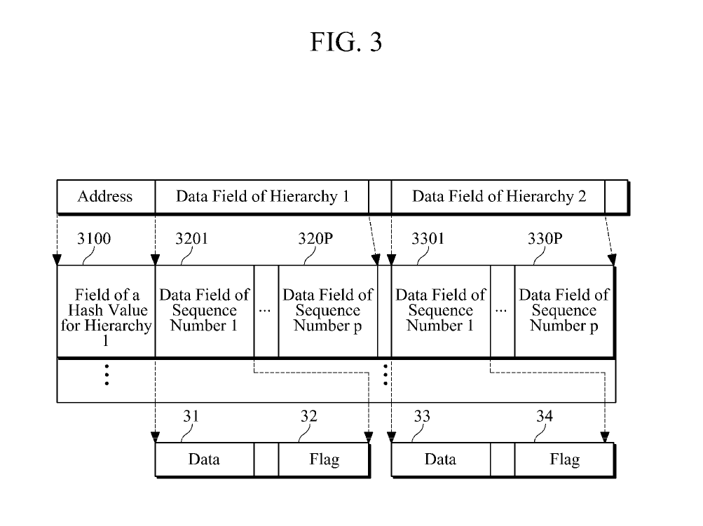

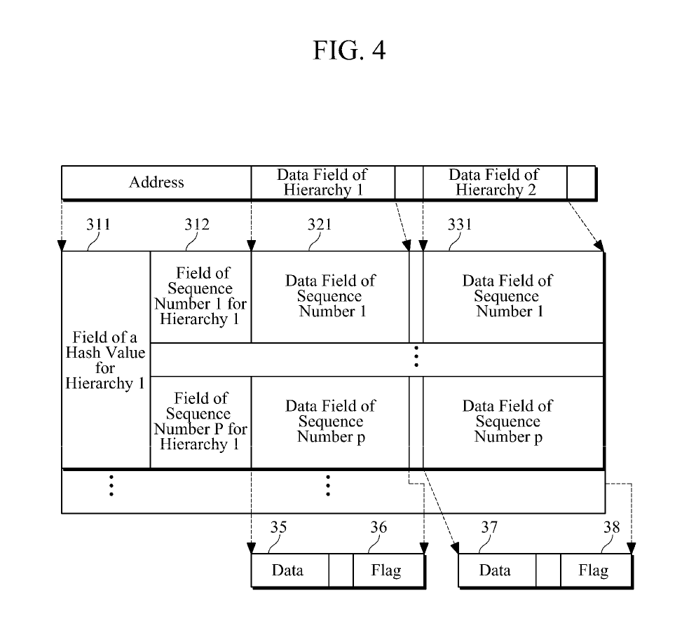

Examples of the common database 23 may vary, as shown in FIGS. 3 and 4, according to first hierarchy hash values generated by the first flow processor 2100 and sequence numbers generated for the respective types of the first hierarchy flows.

Hereinafter, to assist in understanding configuration and operation of the common database 23, it will be described under the assumption that the common database 23 is a direct accessible random access memory (RAM).

FIG. 3 illustrates an example of a memory table of the common database.

The common database 23 is a memory table including an address and data. Referring to the example shown in FIG. 3, the memory table includes the address of a memory which is formed by first hierarchy hash values 3100 generated by the first flow processor 2100, and the data including first hierarchy data fields 3201 to 320p and second hierarchy data fields 3301 to 330p.

The database, as described above, which has the address formed by the first hierarchy hash values and uses sequence numbers as information for identifying the data fields, is advantageous for a task that can generate processing result by collecting and analyzing pieces of cross flow data. A number of second hierarchy data fields are formed corresponding to the number of the sequence numbers generated for the types of the first hierarchy flows.

To ease understanding, it is assumed that the first flow processor 2100 generates p sequence numbers cyclically. Here, p is a natural number. Since the sequence numbers are assigned to pieces of same-type flow data in the input order, flow data having a sequence number 2 is flow data that is input prior to the same-type flow data having a sequence number 3.

Data of the common database 23 includes the first hierarchy data field 3201 of a first hierarchy sequence number 1 to the first hierarchy data field 320p of a first hierarchy sequence number p, and the second hierarchy data field 3301 of a second hierarchy sequence number 1 to the second hierarchy data field 330p of a second hierarchy sequence number p.

Although not illustrated in FIG. 3 for convenience of explanation, the common database 23 may further include a second hierarchy hash value field, and a field of a sequence number for the second hierarchy flow.

In the example shown in FIG. 3, temporal classification of the first hierarchy flows is performed based on the input order of the first hierarchy flow data. A buffer for compensating for a difference of operation time between the first multiprocessor array 2300 of the first hierarchical parallel processing unit 21 and the second multiprocessor array 2700 of the second hierarchical parallel processing unit 22 is provided for database synchronization between the first multiprocessor array 2300 and the second multiprocessor array 2700.

Hereinafter, an example in which each first hierarchy hash value includes p virtual buffers and p data fields are allocated to the each first hierarchy hash value will be described. Pieces of same-type flow data output from the first flow processor 2100 are sequentially assigned with sequence numbers from 1 to p. The assigned sequence numbers cycle from 1 to p repeatedly.

In the example shown in FIG. 3, the number of first hierarchy data fields 3201 to 320p is the same as the number of second hierarchy data fields 3301 to 330p, which is p.

Meanwhile, the first hierarchy data fields 3201 to 320p and the second hierarchy data fields 3301 to 330p may be previously determined or may be determined and updated during operation.

In the example shown in FIG. 3, a flag 34 is to indicate that a corresponding field 3301 to 330p is updated in response to the second multiprocessor array 2700 writing an operation result in the corresponding field of the common database 23.

Thus, the flag 34 is changed to Update-Incomplete in response to the first multiprocessor array 2300 finishing reading a corresponding second hierarchy data field 3301 to 330p of the common database 23.

Another example of checking updating of a corresponding second hierarchy data field 3301 to 330p of the common database 23 is described below.

In the example shown in FIG. 3, a high-order bit of a sequence number which is assigned by the first flow processor 2100 may be used as a flag 34 and the number of second hierarchy data fields of the first database 2410 may be set as being the same as a value obtained by remaining bits except the high-order bit from the sequence number. Then, by comparing a high-order bit of a sequence number of flow data to be processed with a flag of the common database 23, processing synchronization with another hierarchy can be checked.

In the example illustrated in FIG. 3, data 31 and a flag 32 of each first hierarchy data field 3201 to 320p are operated similarly to data 33 and a flag 34 of each second hierarchy is data field 3301 to 330p.

In addition, although not illustrated in FIG. 3, a flag that indicates whether update of a first hierarchy database field and a second hierarchy database field is available or not may be included.

Since the common database 23 includes p data fields for each of the same type flow, p processors can perform parallel-processing simultaneously on pieces of flow data of the same hierarchy.

FIG. 4 illustrates another example of a memory table of the common database.

Referring to an example shown in FIG. 4, the memory table of the common database 23 includes an address of memory which is formed based on first hierarchy hash values 311 and sequence numbers 312 generated for each of types of first hierarchy flows and data which is formed by the first hierarchy data fields 321 and the second hierarchy data fields 331.

Unlike the example shown in FIG. 3, in the example shown in FIG. 4, sequence number fields for a first hierarchy are included in the address, and thus p virtual buffers are provided to a pieces of first hierarchy flow data of the same-type.

Like the example shown in FIG. 3, a plurality of databases which are classified by time are provided with respect to the same type flow, and thus the first multiprocessor array 2300 and the second multiprocessor array 2700 may be able to access the common database 23 concurrently. In a case where the first flow processor 2100 and the second flow processor 2500 do not assign sequence numbers to all flow data of flows, but assign sequence numbers to j pieces of flow data as described above, the sequence numbers for the first hierarchy flows of the same type are generated fewer than p by including the sequence numbers in the address of the memory.

When the second flow processor 2500 does not generate an additional flow, the is second flow processor 2500 may use the sequence numbers assigned by the first flow processor 2100 intact without ordering flows having second hierarchy hash values.

However, when a flow which is not present in a lower hierarchy is additionally generated in a higher hierarchy and a three hierarchical parallel processing unit is further included, the second flow processor 2500 may need additional sequence numbers for the flows having the second hierarchy hash values to identify the flows over the entire hierarchies.

For convenience of explanation, in the examples described above, only the first hierarchical parallel processing unit 21 and the second hierarchical parallel processing unit 22 are provided, depending on applications, three or more hierarchical parallel processing units may be further provided to maximize parallel processing rate.

Hereinafter, an example of a parallel processing apparatus having three or more hierarchical parallel processing units is described.

The parallel processing apparatus may include three or more parallel processing units in a hierarchical manner. The parallel processing unit of each hierarchy includes a corresponding hierarchy database. Also, the parallel processing apparatus may include a common database which is accessed in common by all parallel processing units.

A first hierarchical parallel processing unit may classify data into flows based on a first hierarchy, and generate first hierarchy flows such that flow data can be classified by time or order. In addition, when the number of first hierarchy flow data of the same type which are consecutively input is smaller than a set number, the first hierarchical parallel processing unit may allocate the input consecutive first hierarchy flow data to a processor which is processing first hierarchy flows of the same type. When the number of first hierarchy flow data of the same type which are consecutively input is greater than the set number, the first hierarchical parallel processing unit may allocate some of the input first is hierarchy flow data to a currently available processor to perform operation on the flow data.

A second hierarchical parallel processing unit may receive identification information, order or time information, and the pieces of flow data which are generated by the first hierarchical parallel processing unit, and generate flows which are re-classified such that the flow data can be classified by types and order (or time) based on second hierarchy information. In addition, when the number of second hierarchy flow data of the same type which are consecutively input is smaller than a set number, the second hierarchical parallel processing unit may allocate the input consecutive second hierarchy flow data to a processor which is processing second hierarchy flows of the same type. When the number of second flow data of the same type which are consecutively input is greater than the set number, the second hierarchical parallel processing unit may allocate some of the input second hierarchy flow data to a currently available processor to perform operation on the flow data.

A third hierarchical parallel processing unit may receive classified information, information of order (or time) of assignment, and the pieces of generated flow data from the second hierarchical parallel processing unit, re-classify types of flows based on a three hierarchy, and generate flow data which can be classified by order (or time). In addition, when the number of third hierarchy flow data of the same type which are consecutively input is smaller than a set number, the third hierarchical parallel processing unit may allocate the input consecutive third hierarchy flow data to a processor which is processing third hierarchy flows of the same type. When the number of third flow data of the same type which are consecutively input is greater than the set number, the third hierarchical parallel processing unit may allocate some of the input third hierarchy flow data to a currently available processor to perform operation on the flow data.

In the same manner, a qth hierarchical parallel processing unit (q is a natural number is greater than 3) may receive information classified by a (q−1)th hierarchical parallel processing unit, information of order (or time) that is assigned by the (q−1)th hierarchical parallel processing unit, and flow data generated by the (q−1)th hierarchical parallel processing unit, re-classify flows based on a qth hierarchy, and generate flow data such that the flow data can be classified by order (or time). In addition, when the number of qth hierarchy flow data of the same type which are consecutively input is smaller than a set number, the qth hierarchical parallel processing unit may allocate the input consecutive qth hierarchy flow data to a processor which is processing qth hierarchy flows of the same type. When the number of qth flow data of the same type which are consecutively input is greater than the set number, the qth hierarchical parallel processing unit may allocate some of the input qth hierarchy flow data to a currently available processor to perform operation on the flow data.

Each of the first to qth hierarchical parallel processing units includes a database about a corresponding hierarchy, and a common database is provided which can be accessed in common by all first to qth hierarchical parallel processing units. The common database is synchronized between the hierarchical parallel processing units.

In the examples, it is assumed that the first hierarchy is lower than the second hierarchy and the number of types of first hierarchy flow is smaller than the number of types of second hierarchy flow, but the reverse may occur.

In addition, the first hierarchical parallel processing unit 21 and the second hierarchical parallel processing unit 22 may be configured to be a single chip, or to be separately formed. Furthermore, since the first hierarchical parallel processing unit 21 and the second hierarchical parallel processing unit 22 operate separately, each can be set to power save mode when there is no data flow to be processed.

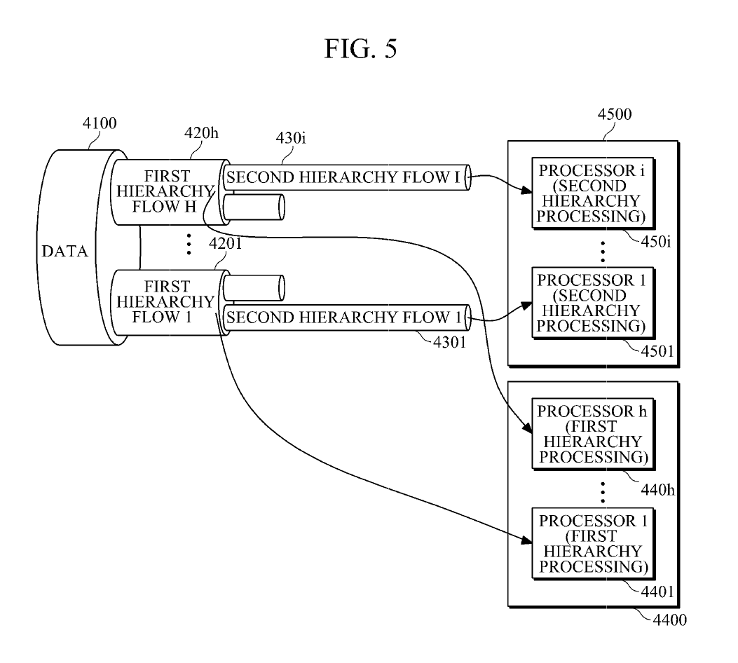

FIG. 5 illustrates an example of a data flow processing method of a multilayer parallel processing apparatus.

Preliminarily, first hierarchy flows 4201 to 420h (h is a natural number) are generated from a data flow 4100. The generated first hierarchy flows are allocated to first hierarchy-processing processors 4401 to 440h of a first hierarchy-processing multiprocessor array 4400 and the first hierarchy flows of the same type are allocated to the identical first hierarchy-processing processor.

In the example shown in FIG. 5, it is assumed that the number of the first hierarchy flows is the same as the number of first hierarchy-processing processors, but the number of the first hierarchy flows and the number of the first hierarchy-processing processors may be different from each other. If the number of first hierarchy flows is smaller than the number of first hierarchy-processing processors, the first hierarchy flows of the same type may be allocated to the first hierarchy-processing processors and sequence numbers assigned by the first flow processor 2100 (see FIG. 2) may be used for maintenance of sequence integrity.

Second hierarchy flows are generated from the preliminarily generated first hierarchy flows, and allocated to second hierarchy-processing processors 4501 to 450i (i is a natural number) of a second hierarchy-processing multiprocessor array 4500, and the second hierarchy flows of the same type are allocated to the same second hierarchy-processing processor. In the example illustrated in FIG. 5, it is assumed that the number of second hierarchy flows is the same as the number of second hierarchy-processing processors, but the numbers of second hierarchy flows and second hierarchy-processing processors may be different from each other. If the number of second hierarchy flows is smaller than the number of second hierarchy-processing processors, the second hierarchy flow data of the same type are allocated to the second hierarchy-processing processors, and sequence numbers of time information are assigned to the second flow data for maintenance of sequence integrity.

As described above, the locality of the first hierarch flow data and the second hierarchy flow data is ensured, thereby providing a basis for processing the first hierarchy flow data and second hierarchy flow data in parallel.

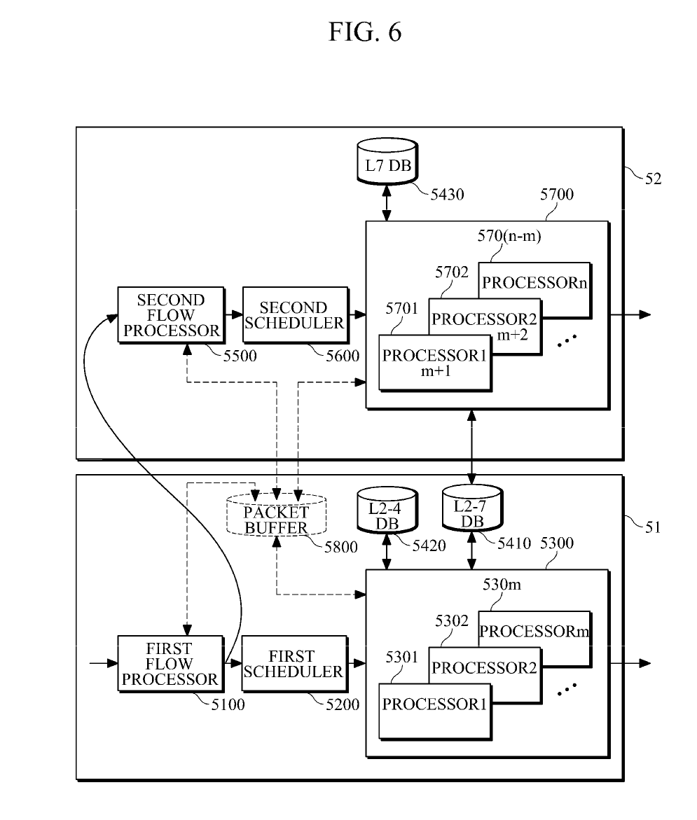

FIG. 6 illustrates an example of a configuration of a multilayer parallel processing apparatus performing deep packet classification (DPC). The a multilayer parallel processing apparatus for DPC may include a lower hierarchical parallel processing unit 51 and a higher hierarchical parallel processing unit 52.

Although in the example illustrated in FIG. 6, the lower hierarchical parallel processing unit 51 and the higher hierarchical parallel processing unit 52 are integrated on a single chip, the lower hierarchical parallel processing unit and the higher hierarchical parallel processing unit may be formed on separate chips or modules.

With respect to an incoming IP packet, a first flow processor 5100 generates a hash key of a lower hierarchy using layer 2-4 information and classification rules of the packet, and generates a hash value to classify the packet and manage a packet state, thereby generating lower hierarchy flows which can be identified by the hash values. The properties of lower hierarchy flows are identified by the hash values and the lower hierarchy flows are temporally identified by sequence numbers (or time).

The first flow processor 5100 may generate a hash key using a source address, a destination address, and a port number among the layer 2-4 information, and information used for the lower hierarchy hash key is mainly header information of the IP packet.

The first flow processor 5100 assigns sequence numbers from 1 to p (p is a natural number greater than 1) cyclically to pieces of flow data identified by layer 2-4, and maintains the order of processor processing results and flow outputs with respect to the consecutive same type flow data. In addition, flow status is managed such that the flow data classified in the higher hierarchy and the flow data classified in the lower hierarchy is correspond to each other one-to-one according to the flow sequence numbers.

Furthermore, a packet buffer 5800 may be further included to efficiently use incoming IP packets in the multiprocessors in common.

The first flow processor 5100 stores incoming IP packets in the packet buffer 5800 such that the IP packets correspond to pieces of flow data temporally identified. By use of the packet buffer 5800, a lower hierarchy multiprocessor array 5300 and a higher hierarchy multiprocessor array 5700 can arbitrarily access contents of flow data, and the second flow processor 5500 can analyze packets.

When the lower hierarchical parallel processing unit 51 and the higher hierarchical parallel processing unit 52 are formed as separate chips or modules, it is difficult for the higher hierarchical parallel processing unit 52 to access the packet buffer 5800, and thus the first flow processor 5100 may need to forward the contents (header and payload) of flow data along with information (a lower hierarchy hash value, a sequence number, and the like) regarding the lower hierarchy flow to the higher hierarchical parallel processing unit 52.

A lower hierarchy scheduler 5200 allocates lower hierarchy flows generated by the first flow processor 5100 to a first processor 5301 to an mth processor 530m of the lower hierarchy multiprocessor array 5300.

There may present three cases, as described above, where the lower hierarchy scheduler 5200 allocates the lower hierarchy flows to the respective processors of the lower hierarchy multiprocessor array 5300.

The first processor 5301 to the mth processor 530m of the lower hierarchy multiprocessor array 5300 access the packet buffer 5800 to use packet header of flow data to be processed (when it is assumed that the lower hierarchy multiprocessor processes header of an IP packet).

The lower hierarchy multiprocessor array 5300 uses a layer 2-4 database 5420 to perform layer 2-4 processing such as forwarding and classification. There may be a is plurality of layer 2-4 databases, which include forwarding/routing table, a classification table, a layer 2-3 quality of service (QoS) table, and the like.

For packet filtering and switching in accordance with bandwidth management and deep packet inspection (DPI) according to packet service properties, the lower hierarchy multiprocessor array 5300 may access a layer 2-7 database 5410 to obtain a result of processing by a higher hierarchy multiprocessor array 5700.

The second flow processor 5500 may generate a higher hierarchy hash key using the higher hierarchy classification rules and at least one of layer 7 information (in practice, data payload of a corresponding address of the packet buffer 5800), lower hierarchy hash information and flow order or time information of the lower hierarchy flow data (in practice, the corresponding address of the packet buffer 5800) forwarded from the first flow processor 5100.

The higher hierarchy hash key is generated such that parallel processing rate of the higher hierarchy multiprocessor array 5700 is maximized, and generates higher hierarchy hash values through an appropriate hash function.

Higher hierarchy flows which are identified by sequence numbers or by time are generated in units of the hash values.

If the second flow processor 5500 of the higher hierarchical parallel processing unit 52 uses the sequence numbers from 1 to p (p is a natural number greater than 1) generated in the lower hierarchy, implemented hardware can be reduced. If the lower hierarchy hash values and the sequence numbers which are generated in the lower hierarchy are designed to be used intact as higher hierarchy hash values and sequence numbers, the second flow processor 5500 uses the lower hierarchy hash values and sequence numbers.

Even when the higher hierarchical parallel processing unit 52 uses the lower hierarchy hash values and the lower hierarchy sequence numbers intact as the higher hierarchy hash values and the higher hierarchy sequence numbers, the consistency can be maintained. In case of two layers, to reduce hardware, the second flow processor 5500 may use the higher hierarchy hash values and the higher hierarchy sequence numbers intact as the lower hierarchy hash values and the lower hierarchy sequence numbers.

A higher hierarchy scheduler 5600 allocates the higher hierarchy flows generated by the second flow processors 5500 to an (m+1)th processor 5701 to an nth processor 570(n-m). The (m+1)th processor 5701 to the nth processor 570(n-m) access to the packet buffer 5800 to use packet payload of flow data to be processed when it is assumed that the higher hierarchy multiprocessor processes payload of the IP packet.

The higher hierarchy multiprocessor array 5700 uses a layer 7 database 5430 to perform layer 7 processing such as DPI, packet capture, payload analysis and the like. There may be a plurality of layer 7 databases, which may include an inspection patter, inspection rules, signatures, and layer 7 QoS tables. The higher hierarchy multiprocessor array 5700 accesses the layer 2-7 database 5410 to use information analyzed by performing DPI.

The higher hierarchy multiprocessor array 5700 uses the lower hierarchy hash values as addresses when accessing the layer 2-7 database 5410.

Since the first processor 5301 to the mth processor 530m of the lower hierarchy multiprocessor array 5300 also use the lower hierarchy hash values to access the layer 2-7 database 5410, the lower hierarchy multiprocessor array 5300 and the higher hierarchy multiprocessor array 5700 can access in common to the layer 2-7 database 5410.

If new higher hierarchy hash values are generated without using the lower hierarchy hash values intact as the higher hierarchy hash values, the layer 7 database 5430 which does not require synchronization and the higher hierarchy multiprocessor array 5700 can be optimized only when the layer 7 database 5430 forms addresses based on the higher hierarchy hash values. The higher hierarchy multiprocessor array 5700 accesses the layer 7 database 5430 in order to perform DPI.

To analyze service properties, transmission schemes, and protocol, the higher hierarchy multiprocessor array 5700 performs pattern or payload check through access to the layer 7 database 5430, and stores the check result in real time to the layer 2-7 database 5410 which is accessed also by the lower hierarchy multiprocessor array 5300. When the lower hierarchy multiprocessor array 5300 performs operation using a result of processing by the higher hierarchy multiprocessor array 5700, since the lower hierarchy flow data and the higher hierarchy flow data corresponds to each other one-to-one, synchronization of the layer 2-7 database is realized using the sequence numbers assigned by the first flow processor 5100.

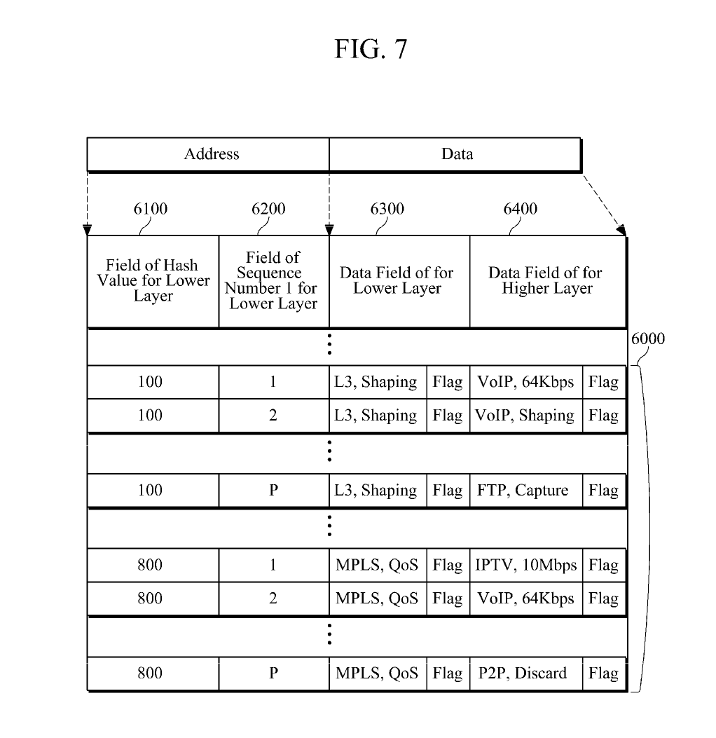

Database synchronization between the lower hierarchy multiprocessor array 5300 and the higher hierarchy multiprocessor array 5700 will now be described with reference to FIG. 7.

FIG. 7 illustrates an example of a memory table of the layer 2-7 database configured based on the example shown in FIG. 4.

In the example shown in FIG. 7, 1 to p in sequence number fields 6200 are sequence numbers which are cyclically assigned to the lower flow data by the first flow processor 5100. In the example shown in FIG. 7, p is a natural number as in the example shown in FIG. 3. Pieces of lower hierarchy 2-4 hash information do not correspond to pieces of higher hierarchy 7 hash information one-to-one. Since flows are generally identified using hash, pieces of flow data identified in layer 2-4 should correspond to pieces of flow data identified in layer 7 when layer 2-4 processing is associated with layer 7 processing. The lower hierarchy multiprocessor array 5300 is required to use layer 7 action 6400 that is an operation result from the higher hierarchy multiprocessor array 5700.

However, layer 7 processing result cannot be identified using layer 2-4 hash values since the layer 2-4 is a lower hierarchy.

Thus, by using the sequence numbers assigned by the first flow processor 5100 is shown in the example illustrated in FIG. 5, the layer 2-7 database 5410 is synchronized in real-time with respect to the lower hierarchy multiprocessor array 5300 and the higher hierarchy multiprocessor array 5700.

As shown in the example illustrated in FIG. 7, since packet sequences (time information) with respect to the lower hierarchy hash values is only present, it is possible to synchronize lower hierarchy information and higher hierarchy information.

The lower hierarchy multiprocessor array 5300 accesses the layer 2-7 database 5410 to use an operation result of the higher hierarchy multiprocessor array 5700.

For example, since it is analyzed that flow data to which a sequence number 1 is assigned, from among the lower hierarchy flow 100 (a layer 2-4 hash value 100), is to be allocated with a bandwidth of 64 Kbps based on VoIP by the higher hierarchy multiprocessor array 5700, the lower hierarchy multiprocessor array 5300 shapes the corresponding flow while guaranteeing the bandwidth as 64 Kbps.

Furthermore, from among the lower hierarchy flow 800 (a layer 2-4 hash value 800), a flow data to which a sequence number p is assigned is discarded from the lower hierarchy multiprocessor array 5300.

Since it is analyzed that from among the lower hierarchy flow 100 (a layer 2-4 hash value 100), flow data to which a sequence number p is assigned is FTP and captures a packet, the corresponding flow is shaped in the lower hierarchy multiprocessor array 5300 and is captured by the higher hierarchy multiprocessor array 5700. In the example illustrated in FIG. 7, flags 6000 are fields for solving asynchronization between the lower hierarchy multiprocessor array 5300 and the higher hierarchy multiprocessor array 5700 due to operation time difference.

The first flow processor 5100 may add a one high-order bit to each sequence number to be generated. When the sequence number is used as an address in the layer 2-7 database 5410, the one high-order bit is removed from the sequence number, and the lower hierarchy multiprocessor array 5300 accesses the layer 2-7 database 5410 and compares the one high-order bit of the sequence number and a bit of a flag (in the example illustrated in FIG. 7, flag 6000). If the comparison result shows that the one high-order bit of the sequence number and a bit of a flag are equal to each other, it indicates that the layer 2-7 database 5410 is updated.

If not equal, it indicates that the layer 2-7 database 5410 has not been updated, and thus the lower hierarchy multiprocessor array 5300 waits for a while, and accesses the layer 2-7 database 5410 again. In the example illustrated in FIG. 7, the flag 6000 is configured to be included in both a lower hierarchy and a higher hierarchy. Updating of the higher hierarchy database of the layer 2-7 database 5410 may be done immediately upon performing operation on one piece of higher hierarchy flow data.

However, since the updating of the higher hierarchy database may be performed after performing operation on several pieces of higher hierarchy flow data, the updating is required to be done properly according to the lower hierarchy flow sequence numbers. Although not illustrated in FIG. 7, if necessary, an update flag may be added. The update flag may be initially set to distinguish a database to be changed in real time and an unchanged database.

As described above, a parallel processing rate of a multiprocessor may be increased, and hierarchies of different properties of data are classified and processed in parallel, a problem related to locality can be overcome.

In addition, a multiprocessor may be designed scalably with respect to functions and performances, and hierarchical operation allows easy control of power consumption. Furthermore, if two or more multiprocessors which are implemented as separate chips link with each other, they can produce the same performance results as a single chip multiprocessor.

A number of examples have been described above. Nevertheless, it may be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multilayer parallel processing apparatus comprising:
two or more hierarchical parallel processing units, each configured to process flow data corresponding to a hierarchy that is allocated thereto in response to inputting pieces of flow data configured with two or more hierarchies; and
a common database configured to be accessed by the two or more hierarchical parallel processing units and store processing results of each of the hierarchical parallel processing units.

2. The multilayer parallel processing apparatus of claim 1, wherein each of the hierarchical parallel processing unit is further configured to comprise
a flow processor configured to generate and output pieces of flow data, to which of each flow identification information is assigned for identifying a flow type of each of the is input flow data,
a scheduler configured to allocate the pieces of flow data output from the flow processor to different processors according to the flow type, and
a multiprocessor array configured to process the pieces of flow data allocated by the scheduler in parallel using the different processors according to the flow type.

3. The multilayer parallel processing apparatus of claim 2, wherein when pieces of flow data of the same type exceeding the number of flow data possible to be processed by one processor are consecutively input, the scheduler is further configured to allocate the excessively input flow data to another processor.

4. The multilayer parallel processing apparatus of claim 2, wherein the flow processor is further configured to assign input order information or input time information to the pieces flow data of the same type to identify the pieces flow data.

5. The multilayer parallel processing apparatus of claim 4, wherein the flow processor is further configured to allocate the input order information or the input time information to a predefined number of flow data among the input pieces of flow data.

6. The multilayer parallel processing apparatus of claim 1, wherein the common database is further configured to comprise
an address field configured to record identification information assigned to flow data corresponding to a lower hierarchy of the two or more hierarchies,
a plurality of lower hierarchy data fields configured to record pieces of flow information identified by the assigned input order information or input time is information according to the flow type of each flow data classified by the identification information recorded in the address field, and
a plurality of higher hierarchy data fields configured to record pieces of higher hierarchy flow information corresponding to the identification information of the lower hierarchy flow data and the input order information or input time information.

7. The multilayer parallel processing apparatus of claim 6, wherein the common database is further configured to include sequence numbers in accordance with the identification information of the lower hierarchy flow data in the address field.

8. The multiplayer parallel processing apparatus of claim 6, wherein the common database is further configured to further comprise an address field configured to record identification information assigned to flow data corresponding to a higher hierarchy.

9. The multilayer parallel processing apparatus of claim 4, wherein the multiprocessor array is further configured to access the common database to obtain data flow processing result information of another hierarchy which is synchronized according to the identification information, and the input order information or input time information and process flow data of the hierarchy.

10. A multilayer parallel processing method in a multilayer parallel processing apparatus which comprises two or more hierarchical parallel processing units and a common database, the multilayer parallel processing method comprising:
receiving pieces of flow data, each configured with two or more hierarchies;
is identifying flow data corresponding to an allocated hierarchy from the received flow data and processing the identified flow data; and
storing a processing result of the flow data to the common database.

11. The multilayer parallel processing method of claim 10, wherein the processing of the identified flow data comprises
assigning flow identification information to each of the pieces of received flow data to identify a flow type of the flow data, and
processing the pieces of flow data identified according to the flow type in parallel.

12. The multilayer parallel processing method of claim 11, wherein when pieces of flow data of the same type exceeding a predefined number are consecutively input, the processing of the identified flow data comprises concurrently processing the input predefined number of flow data of the same type and the rest of flow data in parallel.

13. The multilayer parallel processing method of claim 11, further comprising:
assigning input order information or input time information to the pieces of flow data of the same type.

14. The multilayer parallel processing method of claim 13, wherein the assigning of the input order information or input time information comprises assigning the input order information or input time information to a predefined number of flow data among the pieces of input flow data.

15. The multilayer parallel processing method of claim 12, wherein the processing of the identified flow data comprises reading a flow data processing result of is another hierarchy which is synchronized according to the flow identification information and the input order information or input time information from the common database and using the read flow data processing result.
